(19) United States
(12) Patent Application Publication
(10) Pub. No.: US 2019/0161692 A1
(43) Pub. Date: May 30, 2019

(54) INTEGRATED PROCESSES AND APPARATUSES FOR UPGRADING A HYDROCARBON FEEDSTOCK

(71) Applicant: UOP LLC, Des Plaines, IL (US)

(72) Inventors: Krishna Mani, Gurgaon (IN); Deepak Bisht, Delhi (IN); Steven F. Zink, Westmont, IL (US)

(21) Appl. No.: 15/825,045

(22) Filed: Nov. 28, 2017

(51) Int. Cl. C10G 55/06; C10G 7/00; B01D 53/14; B01D 3/14

(52) U.S. Cl. CPC C10G 55/06; C10G 7/00; B01D 53/1468; B01D 3/143; B01D 2257/304; C10G 2400/10; C10G 2400/04; B01D 2252/204; C10G 2400/06

(57) ABSTRACT

Methods and apparatuses are disclosed for upgrading a hydrocarbon feedstream comprising passing the hydrocarbon feedstream to a first hydroprocessing reactor in a reaction vessel to produce a first hydroprocessed effluent stream. The first hydroprocessed effluent stream is separated in a hot separator to produce a vapor stream and a liquid hydrocarbon stream. At least a portion of the liquid hydrocarbon stream is passed to a second hydroprocessing reactor disposed in the reaction vessel above the first hydroprocessing reactor, to produce a second hydroprocessed effluent stream. A liquid product stream is separated from the second hydroprocessing effluent stream. The vapor stream from the hot separator is mixed with the liquid product stream to provide a combined stream.

### TECHNICAL FIELD

The technical field generally relates to processes and apparatuses for upgrading a hydrocarbon feedstock. More particularly, the technical field relates to an integrated multi-stage hydroprocessing apparatus and processes for upgrading a hydrocarbon feedstock.

### BACKGROUND

In a typical refinery, there are various process which include two or more reaction stages being carried out in two separate reaction vessels with an intermediate separator. Utilizing two reaction vessels is expensive as significant costs and utilities are associated with each of the reactor.

For example, a typical gas oil hydrotreating unit for processing light cycle oil (LCO) along with gas oil requires the addition of an aromatic saturation catalytic unit subsequent to the hydrotreating unit to reduce the aromatic content of the LCO and improve its cetane number. Aromatic saturation reactions are highly exothermic in nature and consume significant hydrogen. Therefore, processing LCO along with gas oil in a gas oil hydrotreater significantly increases the capital expenditure and operational expenditure for the unit due to utilization of two reaction vessels, increased hydrogen consumption and higher cost associated with circulating recycle gas flow for heat management in both the reactors.

Similarly, in the Fischer Tropsch (FT) liquid upgrading process, the current practice is to have two separate reaction vessels for hydrotreating the FT liquid followed by dewaxing to improve the product quality of distillate fraction. The current arrangement also entails high costs and significant utilities associated with each reaction vessel. Further, the current arrangement also suffers from higher cost associated with circulating recycle gas flow for heat management in both the reactors.

In diesel upgrading, the process involves a first reaction vessel in which vacuum gas oil (VGO) is hydrocracked in a mild operating condition leading to a wide product slate containing C₁-C₄, naphtha, kerosene and diesel. Subsequently, the diesel fraction is further subjected to aromatic saturation in a second reaction vessel to improve the cold flow properties such as cloud point, pour point, of the diesel fraction.

In a two stage hydrocracking process, VGO is hydrocracked to a desired conversion level in a first reaction vessel. Subsequently, the unconverted oil (UCO) is further converted in a second reaction vessel.

Group II and Group III base oil stocks are produced by lube hydrocracking of VGO in a reaction vessel followed by catalytic dewaxing and/or hydrodearomatization in a second reaction vessel. Similarly, the hydrocracked bottoms are also used as a feed for producing base oil by catalytic dewaxing and/or hydrodearomatization in a second reaction vessel. Furthermore, used motor oil, which was originally Group II or Group III-rated, can be re-processed by hydroprocessing, after which the hydroprocessed product can be degassed, mixed with hydrogen-rich recycle gas and subjected to a final hydrodearomatization/naphthene ring opening reaction stage in a separate reaction vessel. The hydrodearomatization/naphthene ring opening reaction stage is needed to restore the quality of the used motor oil to the Group III quality rating.

Therefore, the current process as discussed employ two separate reaction vessels with intermediate separation steps to carry out the two stage processes. This results in significant costs and utilities. Further, these processes suffer from higher cost associated with circulating recycle gas flow for heat management in both the reactors and are unable to effectively utilize exothermic heat generated in the process.

Accordingly, it is desirable to provide new apparatuses and processes for providing cost benefits in terms of lower capital and operational expenditures. Further, there is a need for an alternative approach for effective management of exothermic heat from a hydroprocessing zone and to significantly reduce recycle gas rates. Furthermore, other desirable features and characteristics of the present subject matter will become apparent from the subsequent detailed description of the subject matter and the appended claims, taken in conjunction with the accompanying drawings and this background of the subject matter.

### BRIEF SUMMARY

Various embodiments contemplated herein relate to processes and apparatuses for upgrading a hydrocarbon feedstock. The exemplary embodiments taught herein provide an integrated multi-stage hydroprocessing apparatus and processes for upgrading a hydrocarbon feedstock.

In accordance with an exemplary embodiment, an integrated process is provided for upgrading a hydrocarbon feedstream comprising passing the hydrocarbon feedstream to a first hydroprocessing reactor in a reaction vessel, the first hydroprocessing reactor containing at least one bed of a first hydroprocessing catalyst, wherein the hydrocarbon feedstream is contacted with the first hydroprocessing catalyst under first hydroprocessing conditions in the presence of hydrogen to produce a first hydroprocessed effluent stream. The first hydroprocessed effluent stream is separated in a hot separator to produce a vapor stream and a liquid hydrocarbon stream. At least a portion of the liquid hydrocarbon stream is passed to a second hydroprocessing reactor disposed in the reaction vessel above the first hydroprocessing reactor, the second hydroprocessing reactor containing at least one bed of a second hydroprocessing catalyst, wherein the liquid hydrocarbon stream is contacted with the second hydroprocessing catalyst under second hydroprocessing conditions in the presence of hydrogen to produce a second hydroprocessed effluent stream. A liquid product stream is separated from the second hydroprocessing effluent stream. The vapor stream from the hot separator is mixed with the liquid product stream to provide a combined stream.

In accordance with another exemplary embodiment, an integrated process for upgrading a hydrocarbon feedstream comprising passing the hydrocarbon feedstream to a first hydroprocessing reactor in a reaction vessel, the first hydroprocessing reactor containing at least one bed of a first hydroprocessing catalyst, wherein the hydrocarbon feedstream is contacted with the first hydroprocessing catalyst under first hydroprocessing conditions in the presence of hydrogen to produce a first hydroprocessed effluent stream. The first hydroprocessed effluent stream is separated in a hot separator to produce a vapor stream and a liquid hydrocarbon stream. At least a portion of the liquid hydrocarbon stream is passed to a fractionation column to provide a plurality of fractionator product streams. A fractionator product stream from the plurality of fractionator product streams is passed to a second hydroprocessing reactor, the second hydroprocessing reactor containing at least one bed of a second hydroprocessing catalyst, wherein the fractionator product stream is contacted with the second hydroprocessing catalyst under second hydroprocessing conditions in the presence of hydrogen to produce a second hydroprocessed effluent stream comprising a second vapor phase and a liquid product. At least a portion of the second vapor phase from the second hydroprocessing reactor is passed to the first hydroprocessing reactor through a tray having a vapor opening present in the form of one or more chimneys present on the tray, wherein the vapor opening is spaced apart from the tray, and preventing vapor present in the first hydroprocessing reactor from passing to the second hydroprocessing reactor.

In accordance with yet another exemplary embodiment, an integrated apparatus is provided for upgrading a hydrocarbon feedstream comprising a first hydroprocessing reactor in a reaction vessel, the first hydroprocessing reactor containing at least one bed of a first hydroprocessing catalyst. A hot separator is in communication with the first hydroprocessing reactor providing a vapor stream in a hot separator overhead line and a liquid hydrocarbon stream in a hot separator bottoms line. A second hydroprocessing reactor is in communication with the hot separator and disposed in the reaction vessel above the first hydroprocessing reactor, the second hydroprocessing reactor containing at least one bed of a second hydroprocessing catalyst and providing a second hydroprocessing effluent stream. A tray is located between the first hydroprocessing reactor and the second hydroprocessing reactor, the tray having a vapor opening present in the form of one more chimneys present on the tray, wherein the vapor opening is spaced apart from the bottom of the one or more weirs located on the tray. A liquid product line is in communication with the tray withdrawing a liquid product stream from the second hydroprocessing effluent stream and the liquid product line is in communication with the hot separator overhead line to provide a combined line.

It is an advantage to have two reaction stages back-stacked in a single reaction vessel as it enables to carry out multiple reactions in a single reaction vessel, thereby providing cost benefits in terms of lower capital expenditure. Further, the back stacking of reaction stages enables to effectively utilize exothermic heat for process heating, thereby avoiding expensive recycle gas quenching. These and other features, aspects, and advantages of the present invention will become better understood upon consideration of the following detailed description, drawings and appended claims.

### BRIEF DESCRIPTION OF THE DRAWINGS

The various embodiments will hereinafter be described in conjunction with the following FIGURES, wherein like numerals denote like elements.

FIG. 1 is a flow scheme for the process and apparatus of the present invention.

FIG. 2 is another embodiment of the process and apparatus of the present invention.

FIG. 3 is yet another embodiment of the process and apparatus of the present invention.

FIG. 4 is still another embodiment of the process and apparatus of the present invention.

FIG. 5 is another embodiment of the process and apparatus of the present invention.

### DEFINITIONS

As used herein, the term “stream” can include various hydrocarbon molecules and other substances.

As used herein, the term “back-stacked” refers to two or more reaction stages in a reaction vessel wherein a downstream reaction stage is above an upstream reaction stage.

The notation “C_{X}” means hydrocarbon molecules that have “x” number of carbon atoms, C_{X}⁺ means hydrocarbon molecules that have “x” and/or more than “x” number of carbon atoms, and C_{X}⁻ means hydrocarbon molecules that have “x” and/or less than “x” number of carbon atoms.

As used herein, the term “zone” can refer to an area including one or more equipment items and/or one or more sub-zones. Equipment items can include one or more reactors or reactor vessels, heaters, exchangers, pipes, pumps, compressors, controllers and columns. Additionally, an equipment item, such as a reactor, dryer, or vessel, can further include one or more zones or sub-zones.

As used herein, the term “overhead stream” can mean a stream withdrawn at or near a top of a vessel, such as a column.

As used herein, the term “bottoms stream” can mean a stream withdrawn at or near a bottom of a vessel, such as a column.

As depicted, process flow lines in the FIGURES can be referred to interchangeably as, e.g., lines, pipes, feeds, gases, products, discharges, parts, portions, or streams.

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” means that flow from the upstream component enters the downstream component without undergoing a compositional change due to physical fractionation or chemical conversion.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top or overhead pressure is the pressure of the overhead vapor at the vapor outlet of the column. The bottom temperature is the liquid bottom outlet temperature. Overhead lines and bottoms lines refer to the net lines from the column downstream of any reflux or reboil to the column unless otherwise shown. Stripping columns omit a reboiler at a bottom of the column and instead provide heating requirements and separation impetus from a fluidized inert media such as steam.

The term “predominant” means a majority, suitably at least 80 wt % and preferably at least 90 wt %.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description. The Figures have been simplified by the deletion of a large number of apparatuses customarily employed in a process of this nature, such as vessel internals, temperature and pressure controls systems, flow control valves, recycle pumps, etc. which are not specifically required to illustrate the performance of the invention. Furthermore, the illustration of the process of this invention in the embodiment of a specific drawing is not intended to limit the invention to specific embodiments set out herein.

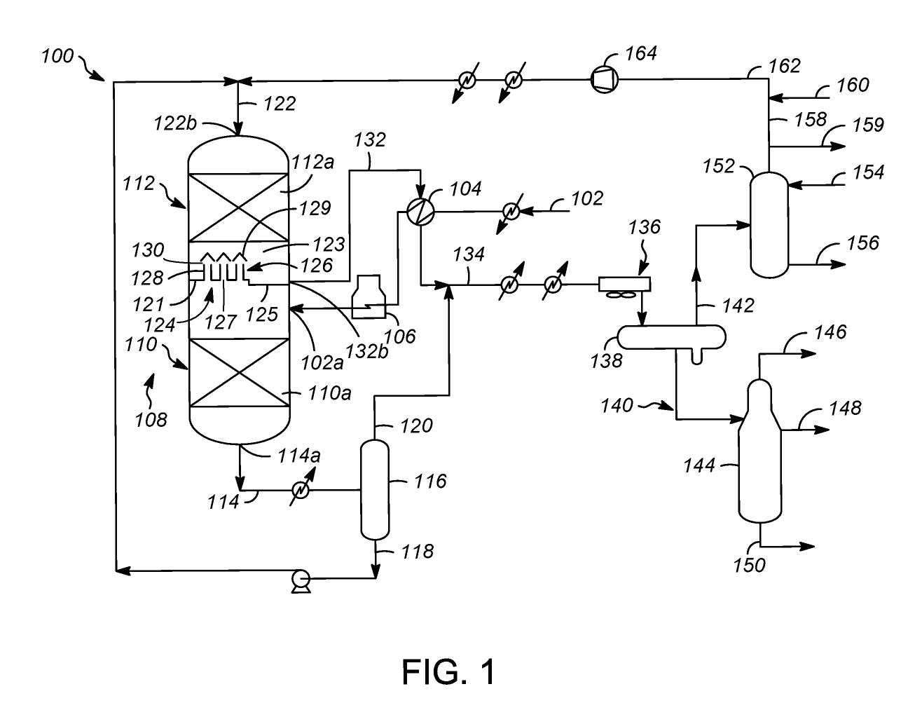

An embodiment of a process for upgrading a hydrocarbon feedstock is addressed with reference to a process and apparatus 100 as shown in FIG. 1. The apparatus and method 100 includes a reaction vessel 108, a first hydroprocessing reactor 110, a second hydroprocessing reactor 112, a hot separator 116, a cold separator 138, a stabilizer column 144 and an amine scrubber column 152. Both the first hydroprocessing reactor 110 and the second hydroprocessing reactor 112 are disposed in the reaction vessel 108 and the second hydroprocessing reactor 112 may be disposed above the first hydroprocessing reactor 110. Further, the reaction vessel 108 includes a tray 124 located between the first hydroprocessing reactor 110 and the second hydroprocessing reactor 112. The tray 124 includes one or more chimneys 126 having one or more weirs 128 and a vapor opening 130. As shown, the vapor opening 130 may be spaced apart from the tray 124 and the bottom of one or more weirs 128 located on the tray 124. The one or more chimneys 126 may include a cap 129 positioned above the top of the one or weirs 128 to define a space therebetween. The one or more weirs 128 are substantially tubular with open ends at each end. The cap 129 is horizontally aligned with a respective opening at a top of each weir 128 and openings in the tray are aligned with a respective opening 127 at a bottom of each weir 128.

The reaction vessel 108 further includes a first feed inlet 102a to a first hydroprocessing reactor 110, a first effluent outlet 114a from the first hydroprocessing reactor 110, a second feed inlet 122b to the second hydroprocessing reactor 112 and a second effluent outlet 132b from the second hydroprocessing reactor 112. The first feed inlet 102a may be located below the second hydroprocessing reactor 112 in the first hydroprocessing reactor 110. Further, at least a portion of the tray 124 may be located between the first feed inlet 102a and the second effluent outlet 132b.

In accordance with an exemplary embodiment as shown in FIG. 1, a hydrocarbon feedstream in line 102 may be passed to the first hydroprocessing reactor 110 in the reaction vessel 108. In an aspect, the first hydrocarbon stream in line 102 may pass through one or more coolers, a heat exchanger 104 and a fired heater 106 before being fed to the first hydroprocessing reactor 110. The hydrocarbon feedstream in line 102 may be introduced to the reaction vessel 108 through the first feed inlet 102a located below the second hydroprocessing reactor 112 in the first hydroprocessing reactor 110. The first hydroprocessing reactor 110 includes at least one bed of a first hydroprocessing catalyst, wherein the hydrocarbon feedstream in line 102 may be contacted with the first hydroprocessing catalyst under first hydroprocessing conditions in the presence of hydrogen vapor to produce a first hydroprocessed effluent stream in line 114. In accordance with an exemplary embodiment as shown in the FIG. 1, the first hydroprocessing reactor 110 includes one bed 110a of the first hydroprocessing catalyst. In an aspect, the first hydroprocessing reactor 110 may include at least two beds of the first hydroprocessing catalyst. The hydrocarbon feedstream in line 102 may be introduced in the reaction vessel 108 on top of the at least one bed 110a of the first hydroprocessing reactor 110. The first hydroprocessing effluent stream in line 114 may be withdrawn through the first effluent outlet 114a. The first hydroprocessed effluent stream in line 114 may be passed to the hot separator 116 for separating the first hydroprocessed effluent in line 114. In an aspect, the first hydroprocessed effluent stream in line 114 may pass through one or more coolers before being passed to the hot separator 116. In accordance with an exemplary embodiment, the hot separator 116 may be in downstream communication with the first hydroprocessing reactor 110 via the first hydroprocessed effluent line 114. In an aspect, the hot separator 116 may be in direct communication with the first hydroprocessing reactor 110 via the first hydroprocessed effluent 114. Accordingly, the first hydroprocessing effluent stream in line 114 may be passed directly to the hot separator 116.

The hot separator 116 separates the first hydroprocessed effluent stream in line 114 into a first vapor phase producing a vapor stream in a hot separator overhead line 120 and a first liquid phase producing a liquid hydrocarbon stream in a hot separator bottoms line 118. At least a portion of the liquid hydrocarbon stream in hot separator bottoms line 118 may be passed to the second hydroprocessing reactor 112 through the second feed inlet 122b. In accordance with an exemplary embodiment, the second hydroprocessing reactor 112 may be in downstream communication with the hot separator 116 through the hot separator bottoms line 118. In another aspect, the second hydroprocessing reactor 112 may be in direct communication with the hot separator 116 through the hot separator bottoms line 118. Accordingly, at least portion of the liquid hydrocarbon stream in hot separator bottoms line 118 from the hot separator 116 may be directly passed to the second hydroprocessing reactor 112. In accordance with various embodiments, another portion of the liquid hydrocarbon stream in hot separator bottoms line 118 may be used as a quench medium in the first hydroprocessing reactor 110. The second hydroprocessing reactor 112 may be disposed in the reaction vessel 108 above the first hydroprocessing reactor 110 and may contain at least one bed of a second hydroprocessing catalyst. In accordance with an exemplary embodiment as shown in the FIG. 1, the second hydroprocessing reactor 112 includes one bed 112a of the second hydroprocessing catalyst. In an aspect, the second hydroprocessing reactor 112 may include at least two beds of the second hydroprocessing catalyst. The liquid hydrocarbon stream in hot separator bottoms line 118 may be contacted with the second hydroprocessing catalyst under second hydroprocessing conditions in the presence of hydrogen to produce a second hydroprocessed effluent stream. In accordance with an exemplary embodiment as shown in the FIG. 1, a hydrogen recycle stream in line 162 may be added to the liquid hydrocarbon stream in hot separator bottoms line 118 to provide a mixed stream in line 122, and the mixed stream in line 122 may be passed to the second hydroprocessing reactor 112 to provide the second hydroprocessing effluent stream. The second hydroprocessing effluent stream may separate into a second liquid phase and a second vapor phase in a disengaging space 123 located below the lowest catalyst bed 112a in the second hydroprocessing reactor 112. The tray 124 may include a lower floor 125 below an upper floor 121 for collecting the liquid product accumulated near the outlet 132b and below a top of the weirs 128. A liquid product stream in line 132 containing at least a portion of the second liquid phase separated from the second hydroprocessing effluent stream may be withdrawn from the lower floor 125 of the tray 124. The liquid product line 132 may be in downstream communication with the tray 124 to withdraw the liquid product from the second hydroprocessing effluent stream through the second effluent outlet 132b. The liquid product in line 132 may be mixed with the vapor stream in hot separator overhead line 120 to provide a combined stream in line 134. As shown, the liquid product line 132 may be in downstream communication with the hot separator overhead line 120 to provide the combined stream in line 134. In an aspect, the liquid product line 132 may be in direct communication with the hot separator overhead line 120 to provide the combined stream in line 134. In an aspect, the liquid product stream in line 132 may pass through a heat exchanger 104 and be heat exchanged with the hydrocarbon feedstream in line 102 to cool the liquid product before combining with the hot separator overhead line 120.

Referring back to second hydroprocessing reactor 112, a second vapor phase separated from the liquid phase of the second hydroprocessing effluent stream in the disengaging space 123 may be passed through the vapor opening 130 through the weir 128 and the opening 127 in the tray 124 to enter the first hydroprocessing reactor 110. However, vapor present in the first hydroprocessing reactor is prevented from passing to the second hydroprocessing reactor 112 through the vapor opening 130. In accordance with an exemplary embodiment, vapor present in the first hydroprocessing reactor 110 is prevented from passing through the vapor opening 130 due to a greater pressure in the second hydroprocessing reactor 112 than in the first hydroprocessing reactor 110. The second hydroprocessing reactor 112 is maintained at a higher pressure than the first hydroprocessing reactor 110. In accordance with an exemplary embodiment, the vapor phase present in the second hydroprocessing effluent passes through openings 127 in the tray 124 to the first hydroprocessing reactor 110. In an aspect, the vapor phase includes hydrogen. In another aspect, the second vapor phase serves as the sole source of hydrogen for the first hydroprocessing reactor 110.

As illustrated, the combined stream in line 134 may be passed to the cold separator 138 to provide a vaporous cold separator overhead stream in line 142 and a liquid cold separator bottoms stream in line 140. The cold separator 138 may be in communication with the reaction vessel 108 through the combined line 134. The combined stream in line 134 may pass through the one or more coolers and an air cooler 136 before passing to the cold separator 138. Subsequently, the liquid cold separator bottoms stream in line 140 may be passed to the stabilizer column 144 to separate light gases and hydrocarbons in line 146 and recover a product stream in line 150 from the bottom of the stabilizer column 144. Further, an intermediate stream in line 148 may be withdrawn from the stabilizer column 144. As shown, the stabilizer column 144 may be in communication with the liquid cold separator bottoms line 140 from the cold separator 138. Although three cuts from the stabilizer column 144 have been shown in the instant embodiment, more or less than three cuts may be obtained from the stabilizer column 144 based on the product requirements.

Referring back to the cold separator 138, the vaporous cold separator overhead stream in line 142 may be passed to the amine scrubber column 152 or other treatment unit, where it may be treated in any conventional manner to remove hydrogen sulfide (H2S) present in the vaporous cold separator overhead stream in line 142. As shown, the amine scrubber column 152 may be in communication with the vaporous cold separator overhead line 142 from the cold separator 138. The amine scrubber column 152 may be utilized without a condenser on an overhead of the column and a reboiler at a bottom of the column. A lean amine stream in line 154 may be introduced to the amine scrubber column 154 for scrubbing the vaporous cold separator overhead stream in line 142. An overhead recycle stream in line 158 comprising hydrogen may be withdrawn from the amine scrubber column 152 and recycled to the second hydroprocessing reactor 112. In an exemplary embodiment as shown in FIG. 1, a make-up hydrogen stream in line 160 may be mixed with the overhead recycle stream in line 158 to provide the hydrogen recycle stream in line 162. In an aspect, a purge gas stream in line 159 may be withdrawn from the overhead recycle stream in line 158 upstream of mixing of the make-up hydrogen stream in line 160. The hydrogen recycle stream in line 162 may pass through a compressor 164 and one or more coolers before being passed to the second hydroprocessing reactor 112. In accordance with various embodiments, hydrogen from the hydrogen recycle stream in line 162 may be added to the to the hydrocarbon feedstream in line 102 prior to introduction to the first hydroprocessing reactor 110. Further, an amine enriched stream in line 156 may be withdrawn from the amine scrubber column 152.

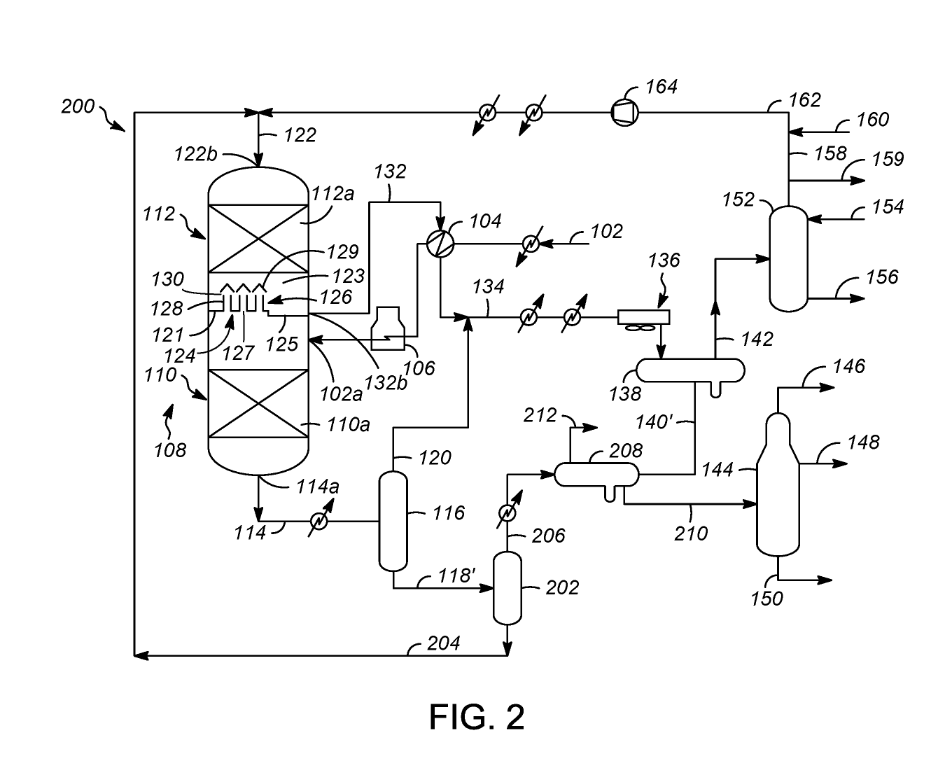

Turning now to FIG. 2, another embodiment for upgrading a hydrocarbon feedstock is addressed with reference to a process and apparatus 200 providing for upgrading a hydrocarbon feedstock wherein the process and apparatus 200 includes a hot flash drum 202 and a cold flash drum 208 in addition to the other apparatus elements of FIG. 1. Many of the elements in FIG. 2 have the same configuration as in FIG. 1 and bear the same respective reference number and have similar operating conditions. Elements in FIG. 2 that correspond to elements in FIG. 1 but have a different configuration bear the same reference numeral as in FIG. 1 but are marked with a prime symbol (′). Further, the temperature, pressure and composition of various streams are similar to the corresponding streams in FIG. 1, unless specified otherwise. The apparatus and process in FIG. 2 are the same as in FIG. 1 with the exception of the noted following differences. In accordance with the exemplary embodiment as shown in the FIG. 2, a liquid hydrocarbon stream in hot separator bottoms line 118′ from the hot separator 116 may be passed to the hot flash drum 202. The hot flash drum 202 may be in downstream communication with the hot separator 116. A hot flash drum bottoms stream in line 204 and a hot flash drum overhead stream in line 206 are withdrawn from the hot flash drum 202. The hot flash drum bottoms stream in line 204 may be passed to the second hydroprocessing reactor 112. The hot flash drum bottoms stream in line 204 may be mixed with the recycle hydrogen stream in line 162 to provide the combined stream 122 which may be processed further as discussed with respect to FIG. 1. Referring back to the hot flash drum 202, the hot flash drum overhead stream in line 206 may be passed to the cold flash drum 208. Further, a liquid cold separator bottoms stream in line 140′ from the cold separator 138 may be also passed to the cold flash drum 208. A cold flash drum bottoms stream in line 210 and a cold flash drum overhead stream in line 212 are withdrawn from the cold flash drum 208. The cold flash drum bottoms stream in line 210 may be passed to the stabilizer column 144 to recover different product cuts as discussed with respect to FIG. 1. The cold flash drum overhead stream in line 212 may be sent to a fuel gas header.

In accordance with an exemplary embodiment, in the process as described with respect to FIG. 1 and FIG. 2, the hydrocarbon feedstream in line 102 may include LCO. In an aspect, the hydrocarbon feedstream in line 102 may include a blend of gas oil and 5-15 vol % LCO. In the instant embodiment, the first hydroprocessing reactor 110 may be a hydrotreating reactor and the second hydroprocessing reactor 112 may be an aromatic saturation reactor. Accordingly, the first hydroprocessing catalyst may be a hydrotreating catalyst and the second hydroprocessing catalyst may be an aromatic saturation catalyst.

Suitable hydrotreating catalysts include those comprising of at least one Group VIII metal, such as iron, cobalt, and nickel (e.g., cobalt and/or nickel) and at least one Group VI metal, such as molybdenum and tungsten, on a high surface area support material such as a refractory inorganic oxide (e.g., silica or alumina). A representative hydrotreating catalyst therefore comprises a metal selected from the group consisting of nickel, cobalt, tungsten, molybdenum, and mixtures thereof (e.g., a mixture of cobalt and molybdenum and a mixture of nickel and molybdenum), deposited on a refractory inorganic oxide support (e.g., alumina). Other suitable hydrotreating catalysts include zeolitic catalysts, as well as noble metal catalysts where the noble metal may be selected from palladium and platinum. The hydrotreating conditions may include a temperature of from about 250° to about 400° C., preferably from about 350° to about 400° C.

Suitable aromatic saturation catalysts include catalysts comprising at least one of nickel or cobalt and molybdenum or tungsten. In an aspect, the aromatic saturation catalyst may be a supported noble metal catalyst. A Group VIII noble metal supported on a support material which includes, for example, alumina, silica, silica-alumina and zirconia may also be used as an aromatic saturation catalyst. A preferred aromatic saturation catalyst contains platinum on amorphous silica-alumina. The aromatic saturation conditions may include a temperature of from about 250° to about 350° C., preferably from about 300° to about 350° C.

In the instant embodiment as described, light ends and light distillates formed in the hydrotreating step in the first hydroprocessing reactor 110 are removed in the vapor stream in hot separator overhead line 120 and the liquid hydrocarbon stream in hot separator bottoms line 118 predominantly contains the aromatics including the mono, di, tri and poly aromatics. Subsequently, the liquid hydrocarbon stream in hot separator bottoms line 118 is passed to the aromatic saturation reactor, which is the second hydroprocessing reactor 112, where aromatics may be saturated to effect an improvement in cetane number. The product stream in line 150 from the bottom of the stabilizer column 144 may comprise upgraded diesel product. Further, the intermediate stream in line 148 comprises naphtha.

In a particular embodiment using a supported noble metal catalyst system as the second hydroprocessing catalyst in the aromatic saturation reactor downstream of the hydrotreating reactor, the apparatus and process comprises the hot flash drum 202 and the cold flash drum 208 as shown and discussed with respect to FIG. 2. The first hydroprocessing effluent stream in line 114 contains light gases such as H₂S and NH₃ as contaminants. However, H₂S and NH₃ act as a poison for the noble metal system and hence in this embodiment the hot flash drum 202 and the cold flash drum 208 are employed as shown in FIG. 2. Accordingly, the liquid hydrocarbon stream in hot separator bottoms line 118′ from the hot separator 116 may be taken to the hot flash drum 202, where the high pressure liquid may be flashed, which ensures complete removal of contaminants such as H₂S and NH₃ before passing the hot flash drum bottoms stream in line 204 to the aromatic saturation reactor.

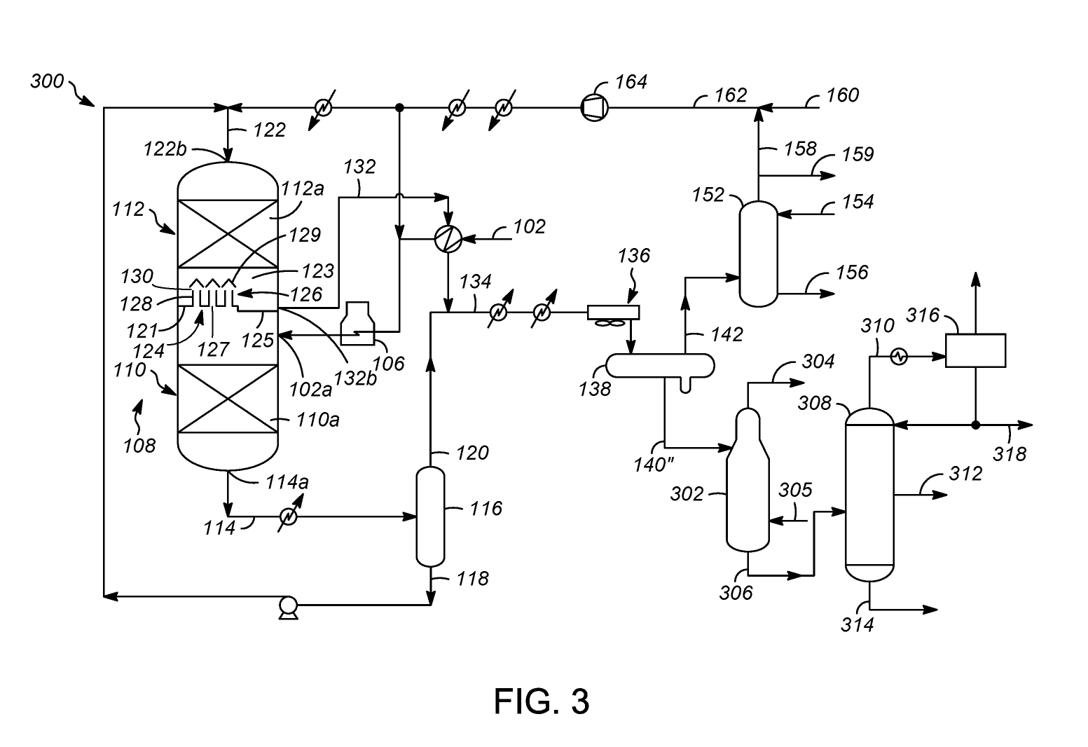

Turning now to FIG. 3, another embodiment for upgrading a hydrocarbon feedstock is addressed with reference to a process and apparatus 300 providing for upgrading a hydrocarbon feedstock wherein the process and apparatus 300 includes a stripper column 302 and a fractionation column 308 in addition to the apparatus elements of FIG. 1 with the exception of the stabilizer column 144. Many of the elements in FIG. 3 have the same configuration as in FIG. 1 and bear the same respective reference number and have similar operating conditions. Elements in FIG. 3 that correspond to elements in FIG. 1 but have a different configuration bear the same reference numeral as in FIG. 1 but are marked with a double prime symbol (″). Further, the temperature, pressure and composition of various streams are similar to the corresponding streams in FIG. 1, unless specified otherwise.

The apparatus and process in FIG. 3 are the same as in FIG. 1 with the exception of the noted following differences. In the instant exemplary embodiment as shown in FIG. 3, a liquid cold separator bottoms stream in line 140″ from the cold separator 138 may be passed to the stripper column 302. The stripper column 302 may be in downstream communication with the second hydroprocessing reactor 112 for stripping the liquid product stream in line 132. A stripping media that may be an inert gas such as steam can be provided as a stripping stream 305. The stripper column 302 may be utilized without a reboiler at a bottom of the column. A stripper overhead stream in line 304 and a stripper bottoms stream in line 306 are withdrawn from the stripper column 302. The stripper bottoms stream in line 306 may be heated with a process heater and fed to the fractionation column 308 to provide a plurality of fractionator product streams. The fractionation column 308 can comprise at least one distillation column, but may be a plurality of distillation columns. The fractionation column 308 may be utilized without a reboiler at a bottom of the column if it has heat supplied by a stripping stream. The product streams may include an overhead stream in line 310, an intermediate stream in line 312 from a side cut outlet, a bottoms stream in line 314. In an exemplary embodiment as shown in FIG. 3, the fractionation column 308 may include a receiver 316. The overhead stream in line 310 may be condensed and separated in a receiver 316 with liquid being refluxed back to the fractionation column 308. An off-gas stream is separated to obtain a net overhead stream in line 318 from the receiver 316.

In accordance with an exemplary embodiment, in the process as described with respect to FIG. 3, the hydrocarbon feedstream in line 102 may include Fischer Tropsch (FT) liquid. In the instant embodiment, the first hydroprocessing reactor 110 may be a hydrotreating reactor and the second hydroprocessing reactor 112 may be a dewaxing reactor. In the instant embodiment having FT liquid as the hydrocarbon feed, the process may be directed to providing high quality distillate by hydrotreating for ultra low sulfur diesel specifications and dewaxing the ultra low sulfur diesel for improving cold flow properties. Accordingly, the first hydroprocessing catalyst may be a hydrotreating catalyst and the second hydroprocessing catalyst may be a dewaxing catalyst.

Suitable hydrotreating catalyst can be conventional hydrotreating catalyst and include those as described above in the instant specification. The hydrotreating conditions may include temperatures ranging from 204° to 482° C. (400° to 900° F.) and pressures ranging from 3.6 to 17.3 MPag (500 to 2500 psig), preferably from 3.6 to 13.9 MPag (500 to 2000 psig).

Exemplary dewaxing catalysts include typical zeolitic dewaxing catalysts that include silicalite or a ZSM-5 type that may be capable of selectively cracking normal paraffins to two or more paraffins with roughly equal numbers of carbon atoms. Preferably, the dewaxing catalyst may be a hydroisomerization catalyst for retaining maximum yields of motor fuel distillates. These dewaxing catalysts may include a base or noble metal so that normal paraffins are isomerized with minimum cracking to achieve the desired or required cold flow properties for the product stream(s). The dewaxing conditions may include pressures of 3.5 to 17.2 MPag (500 to 2500 psig) and temperatures of 232° to 427° C. (450° to 800° F.).

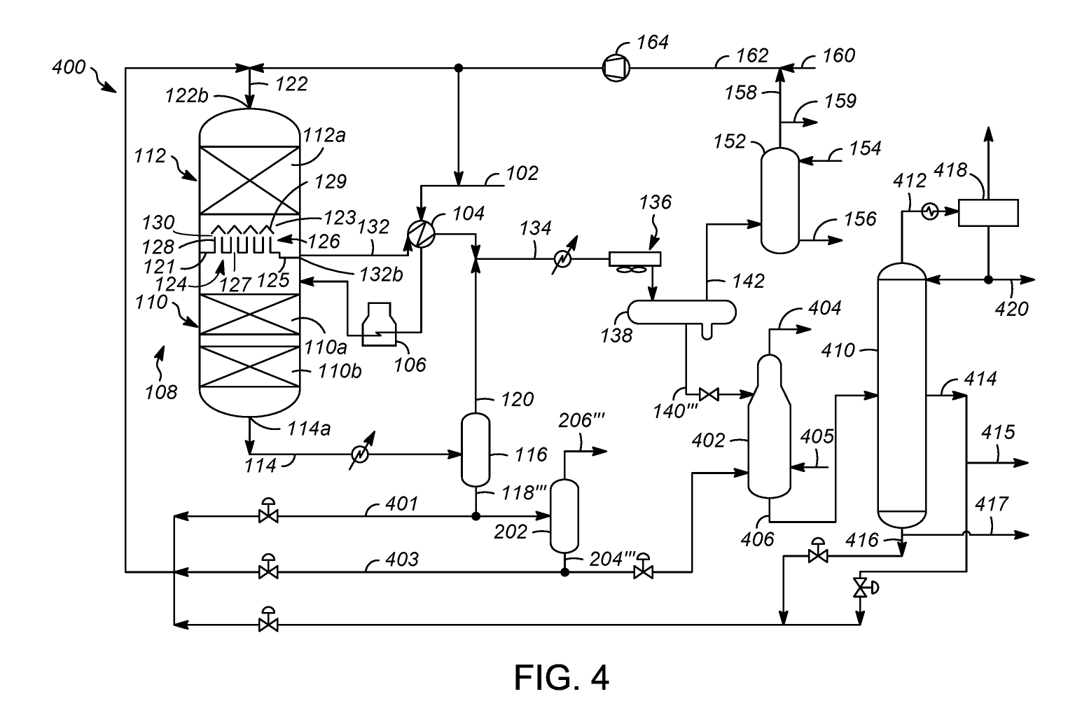

Turning now to FIG. 4, another embodiment for upgrading a hydrocarbon feedstock is addressed with reference to a process and apparatus 400 providing for upgrading a hydrocarbon feedstock wherein the process and apparatus 400 includes a stripper column 402 and a fractionation column 410 in addition to other apparatus elements of FIG. 2 and cold flash drum 208 being optional. In accordance with an exemplary embodiment as shown in the FIG. 4, the first hydroprocessing reactor 110 includes two beds 110a and 110b of the first hydroprocessing catalyst. Many of the elements in FIG. 4 have the same configuration as in FIG. 2 and bear the same respective reference number and have similar operating conditions. Elements in FIG. 4 that correspond to elements in FIG. 2 but have a different configuration bear the same reference numeral as in FIG. 2 but are marked with a triple prime symbol (′″). Further, the temperature, pressure and composition of various streams are similar to the corresponding streams in FIG. 2, unless specified otherwise. The apparatus and process in FIG. 4 are the same as in FIG. 2 with the exception of the noted following differences.

In accordance with an exemplary embodiment as shown in FIG. 4, the separator 116 provides a liquid hydrocarbon stream in hot separator bottoms line 118′″. At least a portion of a liquid hydrocarbon stream in hot separator bottoms line 118′″ may be passed to the fractionation column 410 to provide a plurality of fractionator product streams. In accordance with an exemplary embodiment as shown in the FIG. 4, the liquid hydrocarbon stream in hot separator bottoms line 118″ may be passed to the hot flash drum 202. A hot flash drum bottoms stream in line 204″ and a hot flash drum overhead stream in line 206′ is withdrawn from the hot flash drum 202. The hot flash drum bottoms stream in line 204″ may be passed to the stripper column 402. Further, the liquid cold separator bottoms stream in line 140′ may be also passed to the stripper column 402. In an aspect, the stripper column 402 may be in downstream communication with the hot flash drum 202. A stripping media that can be an inert gas such as steam can be provided as a stripping stream in line 405 to the stripper column 402. The stripper column 402 may be utilized without a reboiler at a bottom of the column. In the stripper column 402, light ends are stripped as stripper overhead stream in line 404 and a stripper bottoms stream in line 406 may be obtained. The stripper bottoms stream in line 406 may be passed to the fractionation column 410 to provide the plurality of fractionator product streams. The fractionation column 410 may be utilized without a reboiler at a bottom of the column. The fractionation column 410 can include any suitable equipment for separating the stripper bottoms stream in line 406 into a plurality of fractionator product streams. The fractionation column 410 can comprise at least one distillation column, but may be a plurality of distillation columns. The fractionator product streams may include an overhead stream in line 412, an intermediate stream in line 414 from a side cut outlet, and a bottoms stream in line 416. In an exemplary embodiment as shown in FIG. 4, the fractionation column 410 may include a receiver 418. The overhead stream in line 412 may be condensed and separated in a receiver 418 with liquid being refluxed back to the fractionation column 410. An off-gas stream is separated to obtain a net overhead stream in line 420 from the receiver 418. A fractionator product stream from the plurality of fractionator product streams may be passed to the second hydroprocessing reactor 112 to obtain the second hydroprocessed effluent stream which may be processed further in accordance with the process as described with respect to FIG. 1. The fractionator product stream to be passed to the second hydroprocessing reactor 112 can be selected and controlled by the presence of valves on one or more product lines corresponding to the plurality of fractionator product streams. In accordance with an exemplary embodiment, a valve on the line 416 may be open and the bottoms stream in line 416 may be passed to the second hydroprocessing reactor 112 and processed as discussed with respect to FIG. 2. In an aspect, a valve on the line 414 may be open and the intermediate stream in line 414 may be passed to the second hydroprocessing reactor 112 and processed as discussed with respect to FIG. 2. In various embodiments, the valves on the both the lines 414 and 416 can be regulated to select the stream to be sent and control the rate of a selected stream sent to the second hydroprocessing reactor 112. In an aspect, a purge stream in line 415 may be withdrawn from the intermediate stream in line 414. In another aspect, a purge stream in line 417 may be withdrawn from the bottoms stream in line 416. In accordance with an exemplary embodiment, at least a portion of the liquid hydrocarbon stream from the hot separator bottoms line 118′″ in a hot separator bottoms transfer line 401 may be passed to the second hydroprocessing reactor 112 with the remaining liquid hydrocarbon stream in separator bottoms line 118′″ being sent to the hot flash drum 202. In such an aspect, a valve on the hot separator bottoms transfer line 401 is open. In various embodiments, the valve on the hot separator bottoms transfer line 401 may be regulated to control the amount of the liquid hydrocarbon stream in hot separator bottoms line 118′″ sent to the second hydroprocessing reactor 112. In accordance with another exemplary embodiment, at least a portion of the hot flash drum bottoms stream in line 204′″ may be passed to the second hydroprocessing reactor 112 in a hot flash bottoms transfer line 403 with the remaining hot flash drum bottoms stream in line 204′″ being sent to the stripper column 402. In such an aspect, a valve on the hot flash bottoms transfer line 403 is open. In various embodiments, the valve on the hot flash bottoms transfer line 403 may be regulated to control the amount of the hot flash drum bottoms stream in line 204′″ sent to the second hydroprocessing reactor 112.

In accordance with an exemplary embodiment, in the process as described with respect to FIG. 4, the hydrocarbon feedstream in line 102 may include vacuum gas oil (VGO). In the instant embodiment, the first hydroprocessing reactor 110 may be a hydrocracking reactor and the second hydroprocessing reactor 112 may be a dewaxing reactor. Accordingly, the first hydroprocessing catalyst may be a hydrocracking catalyst and the second hydroprocessing catalyst may be a dewaxing catalyst.

Exemplary hydrocracking catalysts include zeolitic compounds with a metal from Group VIB and/or VIII, and optionally one or more metals from group VIIA, VIIB, phosphorus, boron, and silicon. Hydrocracking catalysts are known to those skilled in the art. Exemplary reaction conditions in the hydrocracking reactor may include temperatures of 260° to 430° C., and pressures of 3.5 to 17.2 MPag (500 to 2500 psig). Suitable dewaxing catalysts can be conventional dewaxing catalyst and include those as described above in the instant specification. The dewaxing conditions may include pressures of 3.5 to 17.2 MPag (500 to 2500 psig) and temperatures of 232° to 427° C. (450° to 800° F.).

In the instant embodiment as described, a hydrocarbon feedstream in line 102 comprising VGO may be hydrocracked in mild operating conditions in the first hydroprocessing reactor 110. A plurality of fractionator product streams may be obtained from the fractionation column 410 including a naphtha fraction, a middle distillate fraction such as a diesel stream or a kerosene stream, and an unconverted oil fraction. In the instant embodiment, a naphtha stream may be obtained in line 412, a diesel stream may be obtained in line 414 an unconverted oil stream may be obtained in line 416. In one aspect, a valve on the line 414 is open and the diesel stream obtained as the intermediate stream in line 414 from the side cut outlet can be sent to the second hydroprocessing reactor 112 which may be the dewaxing reactor to improve cold flow properties of the diesel including cloud point and pour point properties. In an aspect, the second hydroprocessing reactor 112 may alternatively or further include a hydrodearomatization catalyst comprising base metal sulfide or noble metal catalysts. The hydrodearomatization catalyst may promote naphthene ring opening reactions. The hydrodearomatization catalyst upgrades the diesel product in terms of fuel quality such as cetane number.

In accordance with another exemplary embodiment, in the process as described with respect to FIG. 4, the hydrocarbon feedstream in line 102 may include VGO. In the instant embodiment, both the first hydroprocessing reactor 110 and the second hydroprocessing reactor 112 may be a hydrocracking reactor. Accordingly, the first hydroprocessing catalyst and the second hydroprocessing catalyst may be a hydrocracking catalyst. Suitable hydrocracking catalyst can be conventional hydrocracking catalyst and include those as described above in the instant specification. Exemplary reaction conditions in the hydrocracking reactors may include temperatures of 260° to 430° C., and pressures of 3.5 to 17.2 MPag (500 to 2500 psig).

In the instant embodiment as described, a hydrocarbon feedstream in line 102 comprising VGO may be hydrocracked in the first hydroprocessing reactor 110. In an aspect, the hydrocarbon feedstream in line 102 may be hydrocracked to a desired conversion level. A plurality of fractionator product streams may be obtained from the fractionation column 410 including an unconverted oil stream. In an aspect, the unconverted oil stream may be obtained as the bottoms stream in line 416 from the fractionation column 410. In such an aspect, the valve on line 416 may be open and the unconverted oil stream in the bottoms stream line 416 may be recycled to the second hydroprocessing reactor 112 which may be the hydrocracking reactor to achieve further conversion.

In accordance with yet another exemplary embodiment, in the process as described with respect to FIG. 4, the hydrocarbon feedstream in line 102 may include VGO and the process may be directed to produce lube oils. In the instant embodiment, the first hydroprocessing reactor 110 may be a hydrocracking reactor and the second hydroprocessing reactor 112 may be a dewaxing reactor. Accordingly, the first hydroprocessing catalyst may be a hydrocracking catalyst and the second hydroprocessing catalyst may be a dewaxing catalyst. Suitable hydrocracking catalyst can be conventional hydrocracking catalyst and include those as described above in the instant specification. Suitable dewaxing catalyst can be conventional dewaxing catalyst and include those as described above in the instant specification. In an aspect, in the instant embodiment, the second hydroprocessing reactor 112 may alternatively or further include a hydrodearomatization catalyst comprising base metal sulfide or noble metal catalysts when the first hydroprocessing reactor is a hydrocracking reactor. Exemplary reaction conditions in the hydrocracking reactor may include temperatures of 260° to 430° C., and pressures of 3.5 to 17.2 MPag (500 to 2500 psig). Exemplary reaction conditions for dewaxing may include pressures of 3.5 to 17.2 MPag (500 to 2500 psig) and temperatures of 232° to 427° C. (450° to 800° F.). Exemplary reaction conditions for hydrodearomatization may include pressures of 3.5 to 17.2 MPag (500 to 2500 psig) and temperatures of 232° to 427° C. (450° to 800° F.).

In the instant exemplary embodiment as described, a hydrocarbon feedstream in line 102 comprising VGO may be hydrocracked in the first hydroprocessing reactor 110 to obtain the first hydroprocessing effluent 114 which may be subsequently sent to the fractionation column 410 to obtain the plurality of fractionation product streams. In the instant embodiment, the fractionator product stream comprising the base oil cut may be passed to the second hydroprocessing reactor 112 to provide the liquid product by catalytic dewaxing and/or hydrodearomatization.

In accordance with yet another exemplary embodiment, in the process as described with respect to FIG. 4, the instant flow scheme may be used for re-processing of used motor oil. In the instant embodiment, the hydrocarbon feedstream in line 102 may comprise hydrodemetallized motor oil. In the instant embodiment, the first hydroprocessing reactor 110 may be a hydrocracking reactor and/or a hydrotreating reactor and the second hydroprocessing reactor 112 may be a dewaxing reactor. Accordingly, the first hydroprocessing catalyst may comprise a hydrocracking catalyst and/or a hydrotreating catalyst and the second hydroprocessing catalyst may comprise a dewaxing catalyst. Suitable hydrotreating catalyst can be conventional hydrotreating catalyst and include those as described above in the instant specification. Suitable hydrocracking catalyst can be conventional hydrocracking catalyst and include those as described above in the instant specification. Suitable dewaxing catalyst can be conventional dewaxing catalyst and include those as described above in the instant specification. In an aspect, in the instant embodiment, the second hydroprocessing reactor 112 may alternatively or further include a hydrodearomatization catalyst comprising base metal sulfide or noble metal catalysts. The hydrodearomatization catalyst may promote aromatics saturation and naphthene ring opening reactions to improve oxidation stability and viscosity, respectively. Exemplary reaction conditions for hydrocracking may include temperatures of 260° to 430° C., and pressures of 3.5 to 17.2 MPag (500 to 2500 psig). Exemplary reaction conditions for hydrotreating may include temperatures of 260° to 430° C., and pressures of 3.5 to 17.2 MPag (500 to 2500 psig). Exemplary reaction conditions for dewaxing may include pressures of 3.5 to 17.2 MPag (500 to 2500 psig) and temperatures of 232° to 427° C. (450° to 800° F.). Exemplary reaction conditions for hydrodearomatization may include pressures of 3.5 to 17.2 MPag (500 to 2500 psig) and temperatures of 232° to 427° C. (450° to 800° F.).

In the instant exemplary embodiment as described, the hydrocarbon feedstream in line 102 may comprise hydrodemetallized motor oil that may be hydrocracked and/or hydrotreated in the first hydroprocessing reactor 110 to obtain the first hydroprocessing effluent 114 which may be subsequently sent to the fractionation column 410 to obtain the plurality of fractionation product streams. In the instant embodiment, the fractionator product stream comprising the base oil cut may be passed to the second hydroprocessing reactor 112 to provide the liquid product by catalytic dewaxing and/or hydrodearomatization.

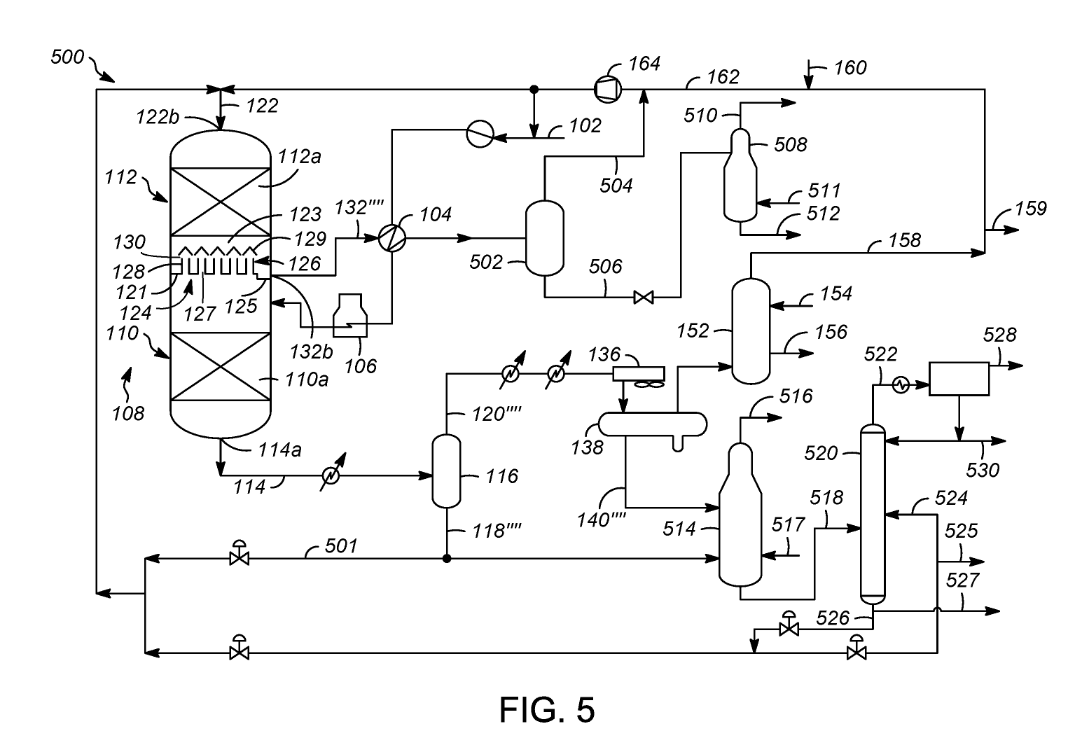

Turning now to FIG. 5, another embodiment for upgrading a hydrocarbon feedstock is addressed with reference to a process and apparatus 500 providing for upgrading a hydrocarbon feedstock wherein the process and apparatus 500 includes an additional cold separator 502, a product stripper 508, a stripper column 514 and a fractionation column 520 in addition to the other apparatus elements of FIG. 1. Many of the elements in FIG. 5 have the same configuration as in FIG. 1 and bear the same respective reference number and have similar operating conditions. Elements in FIG. 5 that correspond to elements in FIG. 1 but have a different configuration bear the same reference numeral as in FIG. 1 but are marked with a quadruple prime symbol (″″). The apparatus and process in FIG. 5 is the same as in FIG. 1 with the exception of the noted following differences. Primarily, the apparatus and process of FIG. 5 differs from FIG. 1 in that the vapor stream from the hot separator 116 does not combine with the liquid product stream from the second hydroprocessing reactor 112. In an aspect, hot separator overhead in line 120″″ may be out of downstream communication with the liquid product in line 132″″. In accordance with an exemplary embodiment as shown in FIG. 5, a liquid hydrocarbon stream in hot separator bottoms line 118″″ and a vapor stream in hot separator overhead line 120″ are produced in the hot separator 116. The vapor stream in hot separator overhead line 120″ may pass through the one or more coolers and the air cooler 136 before passing to the cold separator 138 to provide a liquid cold separator bottoms stream in line 140′. Subsequently, the liquid cold separator bottoms stream in line 140″″ may be passed to the stripper column 514. The liquid hydrocarbon stream in a hot separator bottoms line 118″″ may also be passed to the stripper column 514. The stripper column 514 may be utilized without a reboiler at a bottom of the column. A stripping media that may be an inert gas such as steam can be provided as a stripping stream in a stripping line 517. In the stripper column 514, light ends are stripped from the cold separator bottoms stream to produce a stripper overhead stream in line 516 and a stripper bottoms stream 518. The stripper bottoms stream in line 518 may be passed to the fractionation column 520. The fractionation column 520 can include any suitable equipment for separating the stripper bottoms stream in line 518 into a plurality of fractionator product streams. The fractionation column 520 can comprise at least one distillation, but may be a plurality of distillation columns. The fractionation column 520 may be utilized without a reboiler at a bottom of the column. The product streams may include an overhead stream in line 522, an intermediate stream in line 524 from a side cut outlet, a bottoms stream in line 526. In an aspect, a purge stream in line 525 may be withdrawn from the intermediate stream in line 524. In another aspect, a purge stream in line 527 may be withdrawn from the bottoms stream in line 526. In an exemplary embodiment as shown in FIG. 5, the fractionation column 520 may include a receiver 528. The overhead stream in line 522 may be condensed and separated in a receiver 528 with liquid being refluxed back to the fractionation column 520. An off-gas stream is separated to obtain a net overhead stream in line 530. A fractionator product stream from the plurality of fractionator product streams may be passed to the second hydroprocessing reactor 112 to obtain the second hydroprocessed effluent stream. The fractionator product stream to be passed to the second hydroprocessing reactor 112 can be selected and controlled by the presence of valves on one or more product lines corresponding to the plurality of fractionator product streams. In accordance with an exemplary embodiment as shown in FIG. 5, a valve on line 526 may be open and the bottoms stream in line 526 may be passed to the second hydroprocessing reactor 112. In one aspect, a valve on line 524 may be open and the intermediate stream in line 524 may be passed to the second hydroprocessing reactor 112. In various embodiments, the valves on the both the lines 524 and 526 can be controlled to select the stream to be passed and control the amount sent to the second hydroprocessing reactor 112. In accordance with an exemplary embodiment, at least a portion of the liquid hydrocarbon stream in hot separator bottoms line 118″″ in hot separator bottoms transfer line 501 may be passed to the second hydroprocessing reactor 112 with the remaining liquid hydrocarbon stream in hot separator bottoms line 118″″ being sent to the stripper column 514. In such an aspect, a valve on the hot separator bottoms transfer line 501 is open. In various embodiments, the valve on the hot separator bottoms transfer line 501 may be regulated to control the amount of the liquid hydrocarbon stream in hot separator bottoms line 118″″ sent to the second hydroprocessing reactor 112.

As illustrated, a liquid product stream in line 132″″ containing at least a portion of the liquid phase separated from the second hydroprocessing effluent stream may be withdrawn from the reaction vessel 108. The liquid product line 132″″ may be in downstream communication with the tray 124 to withdraw the liquid product from the second hydroprocessing effluent stream through the second effluent outlet 132b. The liquid product stream in line 132″″ may pass through the heat exchanger 104, be heat exchanged with the hydrocarbon feedstream in line 102 and be passed to the additional cold separator 502. An additional cold separator overhead stream in line 504 comprising light gases including hydrogen and an additional cold separator bottoms streams in line 506 are obtained from the additional cold separator 502. In accordance with an exemplary embodiment as shown in FIG. 5, the additional cold separator overhead stream in line 504 may be passed to the recycle hydrogen stream in line 162. The additional cold separator bottoms stream 506 may be passed to the product stripper 508 to provide an off-gas stream in line 510 and a bottoms product in line 512. A stripping media that may be an inert gas such as steam can be provided as a stripping stream 511 to the product stripper 508.

In accordance with an exemplary embodiment, in the process as described with respect to FIG. 5, the hydrocarbon feedstream in line 102 may include VGO. In the instant embodiment, the first hydroprocessing reactor 110 may be a hydrocracking reactor and the second hydroprocessing reactor 112 may be a dewaxing reactor. Accordingly, the first hydroprocessing catalyst may be a hydrocracking catalyst and the second hydroprocessing catalyst may be a dewaxing catalyst.

Suitable hydrocracking catalysts can be conventional hydrocracking catalyst and include those as described above in the instant specification. Exemplary reaction conditions for hydrocracking may include temperatures of 260° to 430° C., and pressures of 3.5 to 17.2 MPag (500 to 2500 psig). Suitable dewaxing catalyst can be conventional dewaxing catalyst and include those as described above in the instant specification. Exemplary reaction conditions for dewaxing may include pressures of 3.5 to 17.2 MPag (500 to 2500 psig) and temperatures of 232° to 427° C. (450° to 800° F.).

In the instant embodiment as described, a hydrocarbon feedstream in line 102 comprising VGO may be hydrocracked in mild operating conditions in the first hydroprocessing reactor 110. A plurality of fractionator product streams may be obtained from the fractionation column 520 including a naphtha fraction, a middle distillate fraction such as a diesel stream or a kerosene stream, and an unconverted oil fraction. In an aspect, a naphtha stream may be obtained in line 530, a diesel stream is obtained in line 524 an unconverted oil stream may be obtained in line 526. In one aspect, the diesel stream may be obtained as the intermediate stream in line 524 from the side cut outlet and valve on line 524 can be open to pass the diesel stream to the second hydroprocessing reactor 112, which is the dewaxing reactor, to improve cold flow properties of the diesel stream including cloud point and pour point properties. In an aspect, in the instant embodiment, the second hydroprocessing reactor 112 may alternatively or further include a hydrodearomatization catalyst comprising base metal sulfide or noble metal catalysts. The hydrodearomatization catalyst may promote naphthene ring opening reactions. The hydrodearomatization catalyst upgrades the diesel product in terms of fuel quality such as cetane number.

In accordance with yet another exemplary embodiment, in the process as described with respect to FIG. 5, the hydrocarbon feedstream in line 102 may include VGO and the process is directed to produce lube oils. In the instant embodiment, the first hydroprocessing reactor 110 may be a hydrocracking reactor and the second hydroprocessing reactor 112 may be a dewaxing reactor. Accordingly, the first hydroprocessing catalyst may be a hydrocracking catalyst and the second hydroprocessing catalyst may be a dewaxing catalyst. Suitable hydrocracking catalysts can be conventional hydrocracking catalyst and include those as described above in the instant specification. Suitable dewaxing catalysts can be conventional dewaxing catalyst and include those as described above. In an aspect, in the instant embodiment, the second hydroprocessing reactor 112 may alternatively or further include a hydrodearomatization catalyst comprising base metal sulfide or noble metal catalysts. The hydrodearomatization catalyst may promote naphthene ring opening reactions. Exemplary reaction conditions for hydrocracking may include temperatures of 260° to 430° C., and pressures of 3.5 to 17.2 MPag (500 to 2500 psig). Exemplary reaction conditions for dewaxing may include pressures of 3.5 to 17.2 MPag (500 to 2500 psig) and temperatures of 232° to 427° C. (450° to 800° F.).

In the instant exemplary embodiment as described, a hydrocarbon feedstream in line 102 comprising VGO may be hydrocracked in the first hydroprocessing reactor 110 to obtain the first hydroprocessing effluent 114 which may be subsequently passed to the fractionation column 520 to obtain the plurality of fractionation product streams. In the instant embodiment, the fractionator product stream comprising the base oil cut may be passed to the second hydroprocessing reactor 112 to provide the liquid product by catalytic dewaxing and/or hydrodearomatization.

In accordance with yet another exemplary embodiment, in the process as described with respect to FIG. 5, the instant flow scheme may be used for re-processing of used motor oil. In the instant embodiment, the hydrocarbon feedstream in line 102 may comprise hydrodemetallized motor oil. In the instant embodiment, the first hydroprocessing reactor 110 may be a hydrocracking reactor and/or a hydrotreating reactor and the second hydroprocessing reactor 112 may be a dewaxing reactor. Accordingly, the first hydroprocessing catalyst may be a hydrocracking catalyst and/or a hydrotreating catalyst and the second hydroprocessing catalyst may be a dewaxing catalyst. Suitable hydrotreating catalyst can be conventional hydrotreating catalyst and include those as described above in the instant specification. Suitable hydrocracking catalysts can be conventional hydrocracking catalyst and include those as described above in the instant specification. Suitable dewaxing catalyst can be conventional dewaxing catalyst and include those as described above in the instant specification. In an aspect, in the instant embodiment, the second hydroprocessing reactor 112 may alternatively or further include a hydrodearomatization catalyst comprising base metal sulfide or noble metal catalysts. Exemplary reaction conditions for hydrocracking may include temperatures of 260° to 430° C., and pressures of 3.5 to 17.2 MPag (500 to 2500 psig). Exemplary reaction conditions for hydrotreating may include temperatures of 260° to 430° C., and pressures of 3.5 to 17.2 MPag (500 to 2500 psig). Exemplary reaction conditions for dewaxing may include pressures of 3.5 to 17.2 MPag (500 to 2500 psig) and temperatures of 232° to 427° C. (450° to 800° F.). Exemplary reaction conditions for hydrodearomatization may include pressures of 3.5 to 17.2 MPag (500 to 2500 psig) and temperatures of 232° to 427° C. (450° to 800° F.).

In the instant exemplary embodiment as described, the hydrocarbon feedstream in line 102 may comprise hydrodemetallized motor oil may be hydrocracked and/or hydrotreated in the first hydroprocessing reactor 110 to obtain the first hydroprocessing effluent 114 which may be subsequently sent to the fractionation column 520 to obtain the plurality of fractionation product streams. In the instant embodiment, the fractionator product stream comprising the base oil cut may be passed to the second hydroprocessing reactor 112 which may be a dewaxing reactor to provide the liquid product by catalytic dewaxing and/or hydrodearomatization.

### Specific Embodiments

While the following is described in conjunction with specific embodiments, it will be understood that this description is intended to illustrate and not limit the scope of the preceding description and the appended claims.

A first embodiment of the invention is an integrated process for upgrading a hydrocarbon feedstream comprising passing the hydrocarbon feedstream to a first hydroprocessing reactor in a reaction vessel, the first hydroprocessing reactor containing at least one bed of a first hydroprocessing catalyst, wherein the hydrocarbon feedstream is contacted with the first hydroprocessing catalyst under first hydroprocessing conditions in the presence of hydrogen to produce a first hydroprocessed effluent stream; separating the first hydroprocessed effluent stream in a hot separator to produce a vapor stream and a liquid hydrocarbon stream; passing at least a portion of the liquid hydrocarbon stream to a second hydroprocessing reactor disposed in the reaction vessel above the first hydroprocessing reactor, the second hydroprocessing reactor containing at least one bed of a second hydroprocessing catalyst, wherein the liquid hydrocarbon stream is contacted with the second hydroprocessing catalyst under second hydroprocessing conditions in the presence of hydrogen to produce a second hydroprocessed effluent stream; separating a liquid product stream from the second hydroprocessing effluent stream; and mixing the vapor stream from the hot separator with the liquid product stream to provide a combined stream. An embodiment of the invention is one, any or all of prior embodiments in this paragraph up through the first embodiment in this paragraph, wherein the hydrocarbon feedstream is introduced to the reaction vessel between the first hydroprocessing reactor and the second hydroprocessing reactor. An embodiment of the invention is one, any or all of prior embodiments in this paragraph up through the first embodiment in this paragraph further comprising passing vapor phase present in the second hydroprocessing effluent stream to the first hydroprocessing reactor through a tray having a vapor opening present in one or more chimneys present on the tray, wherein the vapor opening is spaced apart from the bottom of one or more weirs located on the tray and preventing vapor present in the first hydroprocessing effluent stream from passing to the second hydroprocessing reactor. An embodiment of the invention is one, any or all of prior embodiments in this paragraph up through the first embodiment in this paragraph, wherein the first hydroprocessing effluent stream is passed directly to the hot separator and the at least portion of the liquid hydrocarbon stream from the hot separator is directly passed to the second hydroprocessing reactor. An embodiment of the invention is one, any or all of prior embodiments in this paragraph up through the first embodiment in this paragraph further comprising passing the combined stream to a cold separator to provide a vaporous cold separator overhead stream and a liquid cold separator bottoms stream. An embodiment of the invention is one, any or all of prior embodiments in this paragraph up through the first embodiment in this paragraph further comprising passing the liquid cold separator bottoms stream to a stabilizer column to separate light gases and hydrocarbons and recover a product stream from the bottom of the stabilizer column. An embodiment of the invention is one, any or all of prior embodiments in this paragraph up through the first embodiment in this paragraph further comprising passing the liquid cold separator bottoms streams to a fractionation column to recover a plurality of fractionator product streams and passing a fractionator product stream from the plurality of fractionator product streams to the second hydroprocessing reactor. An embodiment of the invention is one, any or all of prior embodiments in this paragraph up through the first embodiment in this paragraph further comprising passing the vaporous cold separator overhead stream to an amine scrubber column to provide a hydrogen stream for recycling to the second hydroprocessing reactor. An embodiment of the invention is one, any or all of prior embodiments in this paragraph up through the first embodiment in this paragraph, wherein the first hydroprocessing reactor is one of a hydrotreating reactor and a hydrocracking reactor. An embodiment of the invention is one, any or all of prior embodiments in this paragraph up through the first embodiment in this paragraph, wherein the second hydroprocessing reactor is one of an aromatic saturation reactor, an isomerization reactor, a hydroisomerization/dewaxing reactor and a hydrocracking reactor. An embodiment of the invention is one, any or all of prior embodiments in this paragraph up through the first embodiment in this paragraph, wherein the hydrocarbon feedstream to the first hydroprocessing reactor comprises at least one of a VGO, a feed comprising LCO and/or a coker-derived gasoil, a middle distillate, a Fischer-Tropsch product liquid, a base lube oil, or a used lube oil.

A second embodiment of the invention is an integrated process for upgrading a hydrocarbon feedstream comprising passing the hydrocarbon feedstream to a first hydroprocessing reactor in a reaction vessel, the first hydroprocessing reactor containing at least one bed of a first hydroprocessing catalyst, wherein the hydrocarbon feedstream is contacted with the first hydroprocessing catalyst under first hydroprocessing conditions in the presence of hydrogen to produce a first hydroprocessed effluent stream; separating the first hydroprocessed effluent stream in a hot separator to produce a vapor stream and a liquid hydrocarbon stream; passing at least a portion of the liquid hydrocarbon stream to a fractionation column to provide a plurality of fractionator product streams; passing a fractionator product stream from the plurality of fractionator product streams to a second hydroprocessing reactor, the second hydroprocessing reactor containing at least one bed of a second hydroprocessing catalyst, wherein the fractionator product stream is contacted with the second hydroprocessing catalyst under second hydroprocessing conditions in the presence of hydrogen to produce a second hydroprocessed effluent stream comprising a second vapor phase and a liquid product; and passing at least a portion of the second vapor phase from the second hydroprocessing reactor to the first hydroprocessing reactor through a tray having a vapor opening present in a one or more chimneys present on the tray, wherein the vapor opening is spaced apart from the tray, and preventing vapor present in the first hydroprocessing reactor from passing to the second hydroprocessing reactor. An embodiment of the invention is one, any or all of prior embodiments in this paragraph up through the second embodiment in this paragraph further comprising passing at least a portion of the liquid hydrocarbon stream from the hot separator to the second hydroprocessing reactor.

A third embodiment of the invention is an integrated apparatus for upgrading a hydrocarbon feedstream comprising a first hydroprocessing reactor in a reaction vessel, the first hydroprocessing reactor containing at least one bed of a first hydroprocessing catalyst; a hot separator in communication with the first hydroprocessing reactor providing a vapor stream in a hot separator overhead line and a liquid hydrocarbon stream in a hot separator bottoms line; a second hydroprocessing reactor in communication with the hot separator and disposed in the reaction vessel above the first hydroprocessing reactor, the second hydroprocessing reactor containing at least one bed of a second hydroprocessing catalyst and providing a second hydroprocessing effluent stream; a tray located between the first hydroprocessing reactor and the second hydroprocessing reactor, the tray having a vapor opening present in the one more chimneys present on the tray, wherein vapor opening is spaced apart from the bottom of the one or more weirs located on the tray; and a liquid product line in communication with the tray withdrawing a liquid product stream from the second hydroprocessing effluent stream and the liquid product line is in communication with the hot separator overhead line to provide a combined line. An embodiment of the invention is one, any or all of prior embodiments in this paragraph up through the third embodiment in this paragraph further comprising a first feed inlet to a first hydroprocessing reactor, the first feed inlet being located between the first hydroprocessing reactor and the second hydroprocessing reactor; a first effluent outlet from the first hydroprocessing reactor; a second feed inlet to the second hydroprocessing reactor in downstream communication with the first effluent outlet; and a second effluent outlet from the second hydroprocessing reactor. An embodiment of the invention is one, any or all of prior embodiments in this paragraph up through the third embodiment in this paragraph, wherein the tray is located between the first feed inlet and the second effluent outlet. An embodiment of the invention is one, any or all of prior embodiments in this paragraph up through the third embodiment in this paragraph further comprising a cold separator in communication with the reaction vessel through the combined line from the second effluent outlet. An embodiment of the invention is one, any or all of prior embodiments in this paragraph up through the third embodiment in this paragraph further comprising one of stabilizer column or a fractionation column, in communication with a bottom line from the cold separator. An embodiment of the invention is one, any or all of prior embodiments in this paragraph up through the third embodiment in this paragraph further comprising the second hydroprocessing reactor in communication with a fractionator product line from the fractionation column. An embodiment of the invention is one, any or all of prior embodiments in this paragraph up through the third embodiment in this paragraph further comprising an amine scrubber column in communication with an overhead line from the cold separator.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. An integrated process for upgrading a hydrocarbon feedstream comprising:
passing the hydrocarbon feedstream to a first hydroprocessing reactor in a reaction vessel, the first hydroprocessing reactor containing at least one bed of a first hydroprocessing catalyst, wherein the hydrocarbon feedstream is contacted with the first hydroprocessing catalyst under first hydroprocessing conditions in the presence of hydrogen to produce a first hydroprocessed effluent stream;
separating the first hydroprocessed effluent stream in a hot separator to produce a vapor stream and a liquid hydrocarbon stream;
passing at least a portion of the liquid hydrocarbon stream to a second hydroprocessing reactor disposed in the reaction vessel above the first hydroprocessing reactor, the second hydroprocessing reactor containing at least one bed of a second hydroprocessing catalyst, wherein the liquid hydrocarbon stream is contacted with the second hydroprocessing catalyst under second hydroprocessing conditions in the presence of hydrogen to produce a second hydroprocessed effluent stream;
separating a liquid product stream from the second hydroprocessing effluent stream; and
mixing the vapor stream from the hot separator with the liquid product stream to provide a combined stream.

2. The integrated process of claim 1, wherein the hydrocarbon feedstream is introduced to the reaction vessel between the first hydroprocessing reactor and the second hydroprocessing reactor.

3. The integrated process of claim 1 further comprising passing vapor phase present in the second hydroprocessing effluent stream to the first hydroprocessing reactor through a tray having a vapor opening present in one or more chimneys present on the tray, wherein the vapor opening is spaced apart from the bottom of one or more weirs located on the tray and preventing vapor present in the first hydroprocessing effluent stream from passing to the second hydroprocessing reactor.

4. The integrated process of claim 1, wherein the first hydroprocessing effluent stream is passed directly to the hot separator and the at least portion of the liquid hydrocarbon stream from the hot separator is directly passed to the second hydroprocessing reactor.

5. The integrated process of claim 1 further comprising passing the combined stream to a cold separator to provide a vaporous cold separator overhead stream and a liquid cold separator bottoms stream.

6. The integrated process of claim 5 further comprising passing the liquid cold separator bottoms stream to a stabilizer column to separate light gases and hydrocarbons and recover a product stream from the bottom of the stabilizer column.

7. The integrated process of claim 5 further comprising passing the liquid cold separator bottoms streams to a fractionation column to recover a plurality of fractionator product streams and passing a fractionator product stream from the plurality of fractionator product streams to the second hydroprocessing reactor.

8. The integrated process of claim 5 further comprising passing the vaporous cold separator overhead stream to an amine scrubber column to provide a hydrogen stream for recycling to the second hydroprocessing reactor.

9. The integrated process of claim 1, wherein the first hydroprocessing reactor is one of a hydrotreating reactor and a hydrocracking reactor.

10. The integrated process of claim 9, wherein the second hydroprocessing reactor is one of an aromatic saturation reactor, an isomerization reactor, a hydroisomerization/dewaxing reactor and a hydrocracking reactor.

11. The integrated process of claim 1, wherein the hydrocarbon feedstream to the first hydroprocessing reactor comprises at least one of a VGO, a feed comprising LCO and/or a coker-derived gasoil, a middle distillate, a fischer-tropsch product liquid, a base lube oil, or a used lube oil.

12. An integrated process for upgrading a hydrocarbon feedstream comprising:
passing the hydrocarbon feedstream to a first hydroprocessing reactor in a reaction vessel, the first hydroprocessing reactor containing at least one bed of a first hydroprocessing catalyst, wherein the hydrocarbon feedstream is contacted with the first hydroprocessing catalyst under first hydroprocessing conditions in the presence of hydrogen to produce a first hydroprocessed effluent stream;
separating the first hydroprocessed effluent stream in a hot separator to produce a vapor stream and a liquid hydrocarbon stream;
passing at least a portion of the liquid hydrocarbon stream to a fractionation column to provide a plurality of fractionator product streams;
passing a fractionator product stream from the plurality of fractionator product streams to a second hydroprocessing reactor, the second hydroprocessing reactor containing at least one bed of a second hydroprocessing catalyst, wherein the fractionator product stream is contacted with the second hydroprocessing catalyst under second hydroprocessing conditions in the presence of hydrogen to produce a second hydroprocessed effluent stream comprising a second vapor phase and a liquid product; and
passing at least a portion of the second vapor phase from the second hydroprocessing reactor to the first hydroprocessing reactor through a tray having a vapor opening present in a one or more chimneys present on the tray, wherein the vapor opening is spaced apart from the tray, and preventing vapor present in the first hydroprocessing reactor from passing to the second hydroprocessing reactor.

13. The integrated process of claim 12 further comprising passing at least a portion of the liquid hydrocarbon stream from the hot separator to the second hydroprocessing reactor.

14. An integrated apparatus for upgrading a hydrocarbon feedstream comprising:
a first hydroprocessing reactor in a reaction vessel, the first hydroprocessing reactor containing at least one bed of a first hydroprocessing catalyst;
a hot separator in communication with the first hydroprocessing reactor providing a vapor stream in a hot separator overhead line and a liquid hydrocarbon stream in a hot separator bottoms line;
a second hydroprocessing reactor in communication with the hot separator and disposed in the reaction vessel above the first hydroprocessing reactor, the second hydroprocessing reactor containing at least one bed of a second hydroprocessing catalyst and providing a second hydroprocessing effluent stream;
a tray located between the first hydroprocessing reactor and the second hydroprocessing reactor, the tray having a vapor opening present in the one more chimneys present on the tray, wherein vapor opening is spaced apart from the bottom of the one or more weirs located on the tray; and
a liquid product line in communication with the tray withdrawing a liquid product stream from the second hydroprocessing effluent stream and the liquid product line is in communication with the hot separator overhead line to provide a combined line.

15. The integrated apparatus of claim 14 further comprising:
a first feed inlet to a first hydroprocessing reactor, the first feed inlet being located between the first hydroprocessing reactor and the second hydroprocessing reactor;
a first effluent outlet from the first hydroprocessing reactor;
a second feed inlet to the second hydroprocessing reactor in downstream communication with the first effluent outlet; and
a second effluent outlet from the second hydroprocessing reactor.

16. The integrated apparatus of claim 15, wherein the tray is located between the first feed inlet and the second effluent outlet.

17. The integrated apparatus of claim 15 further comprising a cold separator in communication with the reaction vessel through the combined line from the second effluent outlet.

18. The integrated apparatus of claim 17 further comprising one of stabilizer column or a fractionation column, in communication with a bottom line from the cold separator.

19. The integrated apparatus of claim 18 further comprising the second hydroprocessing reactor in communication with a fractionator product line from the fractionation column.

20. The integrated apparatus of claim 17 further comprising an amine scrubber column in communication with an overhead line from the cold separator.
